(19) United States
(12) Patent Application Publication
(10) Pub. No.: US 2015/0345211 A1
(43) Pub. Date: Dec. 3, 2015

(54) WEATHERSTRIP SEAL, METAL INSERT THEREFOR AND METHOD FOR MANUFACTURING THE SAME

(71) Applicant: WATERVILLE TG INC., Waterville (CA)

(72) Inventors: Marie-Josée Bernier, Sherbrooke (CA); Yannick Longpré, Sherbrooke (CA)

(21) Appl. No.: 14/725,756

(22) Filed: May 29, 2015

Related U.S. Application Data
(60) Provisional application No. 62/005,668, filed on May 30, 2014.

(51) Int. Cl. E06B 7/23; B21D 5/16; B21D 35/00; B60J 10/08

(52) U.S. Cl. CPC E06B 7/2305; B60J 10/08; B21D 5/16; B21D 35/002

(57) ABSTRACT

There is provided a metal insert for a weatherstrip seal comprising: an elongate central portion having a pair of spaced-apart lateral edges and a central longitudinal axis; at least one flap extending from one of the spaced-apart lateral edges, the at least one flap being folded at an angle relative to the elongate central portion about a folding axis generally parallel to the central longitudinal axis, the at least one flap comprising a plurality of fins spaced apart to define interstitial spaces between adjacent fins, each interstitial space comprising an inner end portion located near the central longitudinal portion and a notch extending from the inner end portion towards the central longitudinal axis and beyond the folding axis. There is also provided a weatherstrip seal including the metal insert and a method for manufacturing the metal insert.

### CROSS-REFERENCE TO RELATED APPLICATIONS

This application claims priority 35 U.S.C. §119 of U.S. Provisional Patent Application No. 62/005,668, filed on May 30, 2015, the specification of which is incorporated herein by reference.

### TECHNICAL FIELD

The invention relates to weatherstrip seals and to metal inserts for weatherstrip seals, and more specifically to weatherstrip seals and to inserts for sealing curved areas. The invention also relates to a method for manufacturing a metal insert for a weatherstrip seal.

### BACKGROUND

Weatherstrip seals are usually used around to seal off areas around doors and windows on structures and vehicle. Typically, weatherstrip seals comprise an internal metal core or carrier, also known as an insert, which is covered by an outer layer of elastomeric material. The metal insert provides relative cross-sectional rigidity to the weatherstrip seal to allow the weatherstrip seal to be clasped to part of a structure or a vehicle such that it is retained on said structure or vehicle, while the elastomeric material gives the weatherstrip seal its sealing properties and/or its desired shape.

The metal insert usually consists of an elongate, flat piece of sheet metal comprising a central portion and lateral flanges or flaps which are folded up towards each other such that the metal insert has a generally U-shaped cross-section.

In some case, it may be required to curve the weatherstrip seal lengthwise to follow a curved portion of the area to be sealed. For this purpose, the flaps, rather than being continuous, are usually made of a plurality of spaced-apart tabs or fins which extend generally parallel to each other when the weatherstrip seal is linear. When the weatherstrip seal is curved, the fins “fan out” (i.e. are angled relative to each other), thereby allowing the metal insert to retain its generally U-shaped cross-section even when curved.

Inserts for weatherstrip seals can have various configurations. For example, the fins may have different lengths, different shapes, or a specific pattern may be cut into the metal insert, and more specifically in the central portion of the metal insert. Each specific configuration may enhance one or more characteristics of the weatherstrip seal such as lightness, rigidity, tensile resistance or strength, ease of manufacturing, ability to retain its cross-sectional shape when curved, etc. Unfortunately, the configurations currently provided will usually enhance one of these characteristics at the expense of the others.

There is therefore a need for a weatherstrip seal and a metal insert for a weatherstrip seal which would overcome at least one of the above-identified drawbacks.

### BRIEF SUMMARY

According to one aspect, there is provided a metal insert for a weatherstrip seal comprising: an elongate central portion having a pair of spaced-apart lateral edges and a central longitudinal axis; and at least one flap extending from one of the spaced-apart lateral edges, the at least one flap being folded at an angle relative to the elongate central portion about a folding axis generally parallel to the central longitudinal axis, the at least one flap comprising a plurality of fins spaced apart to define interstitial spaces between adjacent fins, each interstitial space comprising an inner end portion located near the central longitudinal portion and a notch extending from the inner end portion towards the central longitudinal axis and beyond the folding axis.

In one embodiment, the notch comprises two spaced-apart side edges and an inner corner extending between the two spaced-apart side edges.

In one embodiment, the two spaced-apart edges are parallel to each other.

In one embodiment, the two spaced-apart edges are perpendicular to the central longitudinal axis of the elongate central portion.

In a further embodiment, the two spaced-apart edges are spaced by a distance of 0.76 mm.

In one embodiment, the inner corner is rounded.

In a further embodiment, the inner corner is rounded at a radius of 0.38 mm.

In one embodiment, the inner end portion of each interstitial space tapers towards the central longitudinal axis of the elongate central portion.

In one embodiment, the metal insert further comprises a plurality of openings disposed according to a predetermined pattern.

In one embodiment, the plurality of openings comprises a row of central openings aligned along the central longitudinal axis of the elongate central portion.

In one embodiment, the plurality of openings further comprises a pair of rows of lateral openings off-centered relative to the central longitudinal axis and symmetrical to each other about the central longitudinal axis.

In one embodiment, the central openings and the lateral openings are disposed in a staggered pattern.

In one embodiment, the central openings are diamond-shaped.

In one embodiment, the lateral openings are hexagonal.

In one embodiment, the elongate central portion further comprises a web of webbing strips surrounding the central openings and the lateral openings.

In a further embodiment, all of the webbing strips have the same width.

In one embodiment, the at least one flap and the elongate central portion are integrally formed together from a sheet of metal.

In one embodiment, the metal is selected from a group consisting of: aluminum and an alloy thereof.

According to another aspect, there is also provided a weatherstrip seal comprising: a metal insert including an elongate central portion having a pair of spaced-apart lateral edges and a central longitudinal axis; at least one flap extending from one of the spaced-apart lateral edges, the at least one flap being folded at an angle relative to the elongate central portion about a folding axis generally parallel to the central longitudinal axis, the at least one flap comprising a plurality of fins spaced apart to define interstitial spaces between adjacent fins, each interstitial space comprising an inner end portion located near the central longitudinal portion and a notch extending from the inner end portion towards the central longitudinal axis and beyond the folding axis; and a layer of elastomeric material covering the metal insert.

According to yet another aspect, there is also provided a vehicle comprising a weatherstrip seal comprising: a metal insert including an elongate central portion having a pair of spaced-apart lateral edges and a central longitudinal axis; at least one flap extending from one of the spaced-apart lateral edges, the at least one flap being folded at an angle relative to the elongate central portion about a folding axis generally parallel to the central longitudinal axis, the at least one flap comprising a plurality of fins spaced apart to define interstitial spaces between adjacent fins, each interstitial space comprising an inner end portion located near the central longitudinal portion and a notch extending from the inner end portion towards the central longitudinal axis and beyond the folding axis; and a layer of elastomeric material covering the metal insert.

According to yet another aspect, there is also provided a method for manufacturing a metal insert for a weatherstrip seal, the method comprising: providing an elongate blank piece of sheet metal having a first lateral edge, a second lateral edge and a central longitudinal axis; cutting a plurality of spaced-apart interstitial spaces in the blank piece of sheet metal, the interstitial spaces extending from at least one of the lateral edges towards the central longitudinal axis, each interstitial space comprising an inner end portion located near the central longitudinal portion and a notch extending from the inner end portion towards the central longitudinal axis, the interstitial spaces being spaced apart to define a plurality of fins between adjacent interstitial spaces; defining at least one folding axis extending parallel to the central longitudinal axis, each folding axis delimiting a flap including the fins from an elongate central portion, said folding axis intersecting said notch such that the notch extends beyond the folding axis; folding the fins about the at least one folding axis at an angle relative to the elongate central portion.

In one embodiment, the method further comprises, simultaneously to cutting the plurality of spaced-apart interstitial spaces, cutting a row of central openings aligned with the central longitudinal axis and a pair of rows of lateral openings offset from the central longitudinal axis into the blank piece of sheet metal.

In one embodiment, cutting the plurality of spaced-apart interstitial spaces is done by stamping.

According to yet another aspect, there is also provided a method for manufacturing a weatherstrip seal, the method comprising: manufacturing a metal insert as described above; covering the metal insert with a layer of elastomeric material; curing the layer of elastomeric material.

According to yet another aspect, there is also provided a method for manufacturing a weatherstrip seal, the method comprising: covering the metal insert as described above with a layer of elastomeric material; curing the layer of elastomeric material.

According to yet another aspect, there is also provided metal insert for a weatherstrip seal comprising: an elongate central portion having a pair of spaced-apart lateral edges and a central longitudinal axis, the elongate central portion further including a plurality of openings extending through the elongate central portion, the plurality of openings including a row of central openings aligned along the central longitudinal axis of the elongate central portion and a pair of rows of lateral openings off-centered relative to the central longitudinal axis and symmetrical to each other about the central longitudinal axis, the central openings and the lateral openings being disposed in a staggered pattern, the elongate central portion comprising a web of webbing strips surrounding the central openings and the lateral openings, all of the webbing strips have the same width; a pair of flaps connected to the elongate central portion, each flap extending from one of the spaced-apart lateral edges and being folded at an angle relative to the elongate central portion about a folding axis generally parallel to the central longitudinal axis, each flap comprising a plurality of fins spaced apart to define interstitial spaces between adjacent fins, each interstitial space comprising an inner end portion located near the central longitudinal portion and a notch extending from the inner end portion towards the central longitudinal axis and beyond the folding axis.

### BRIEF DESCRIPTION OF THE DRAWINGS

FIG. 1 is a side view of a weatherstrip seal, in accordance with one embodiment, in which the weatherstrip seal is curved outwardly and a portion of the elastomeric layer is removed to show the metal insert within the weatherstrip seal;

FIG. 2 is a top view of the metal insert for the weatherstrip seal shown in FIG. 1, with the metal insert curved outwardly;

FIG. 3 is a side view of the metal insert for the weatherstrip seal shown in FIG. 1, with the metal insert curved outwardly;

FIG. 3A is a cross-section view, taken along cross-section line IIIA-IIIA of FIG. 3, of the metal insert for the weatherstrip seal shown in FIG. 1, with the metal insert curved outwardly;

FIG. 4 is a top view of a non-folded metal insert for forming the metal insert for the weatherstrip seal shown in FIG. 1, to better show openings and interstitial spaces on the metal insert;

FIG. 4A is a top view, enlarged, showing part of the non-folded metal insert shown in FIG. 4;

FIG. 5 is a side view of the metal insert for the weatherstrip seal shown in FIG. 1, with the metal insert in a linear configuration;

FIG. 5A is a cross-section view, taken along cross-section line VA-VA of FIG. 5, of the metal insert for the weatherstrip seal shown in FIG. 1, with the metal insert in a linear configuration;

FIG. 6 is a side view of the metal insert for the weatherstrip seal shown in FIG. 1, with the metal insert curved inwardly;

FIG. 6A is a cross-section view, taken along cross-section line VIA-VIA of FIG. 6, of the metal insert for the weatherstrip seal shown in FIG. 1, with the metal insert curved inwardly; and

FIG. 7 is a flowchart of a method for manufacturing the metal insert for the weatherstrip seal shown in FIG. 1.

Further details of the invention and its advantages will be apparent from the detailed description included below.

### DETAILED DESCRIPTION

In the following description of the embodiments, references to the accompanying drawings are by way of illustration of an example by which the invention may be practiced. It will be understood that other embodiments may be made without departing from the scope of the invention disclosed.

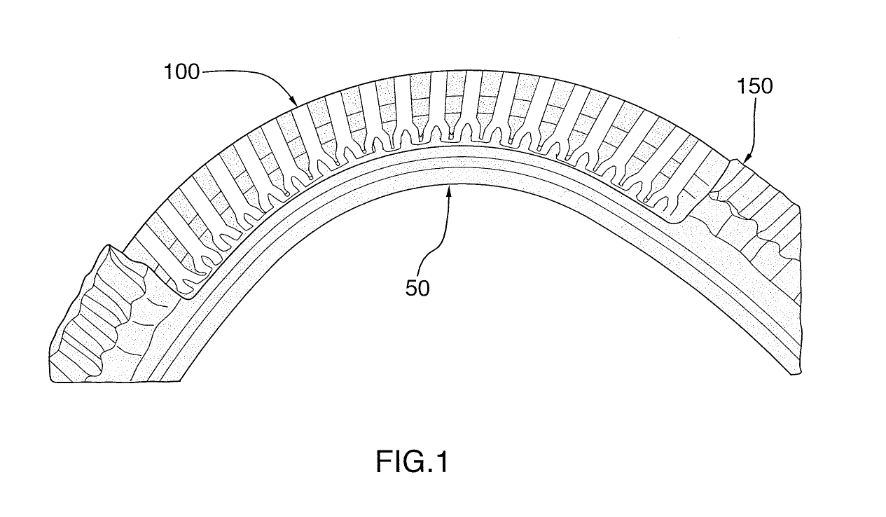

Referring first to FIG. 1, there is provided a weatherstrip seal 50, in accordance with one embodiment. The weatherstrip seal 50 could be used for the weatherstripping of a vehicle. For example, the weatherstrip seal 50 may be mounted on the body of a vehicle, and more specifically on a peripheral portion of the body around a car door opening. Alternatively, the weatherstrip seal 50 could be mounted on a car door or on another moving part of the structure or vehicle. In yet another embodiment, the weatherstrip seal 50 could be used for the weatherstripping of a building or of any other structure which may require sealing.

In the present embodiment, the weatherstrip seal 50 comprises a metal insert 100 and a layer of elastomeric material 150 covering the metal insert 100. In this configuration, the metal insert 100 acts as a skeleton to provide relative rigidity to the weatherstrip seal 50, while the layer of elastomeric material 150 is resilient to create sealing when the weatherstrip seal 50 is pressed or simply disposed between two portions of a structure or vehicle, such as between a car door and a car door frame. The elastomeric material could comprise rubber, thermoplastic elastomer (TPE) or any other material that a skilled addressee may deem fit for the intended use of the weatherstrip seal.

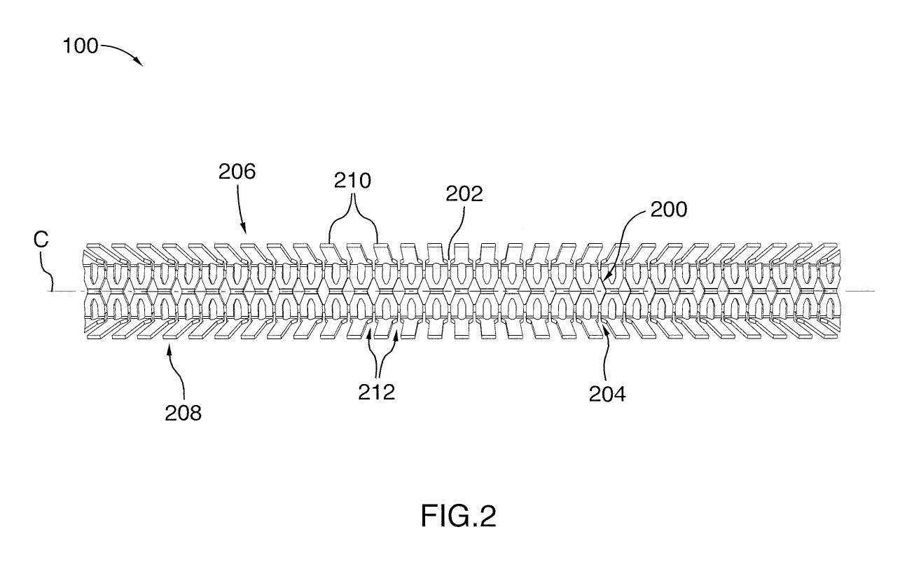

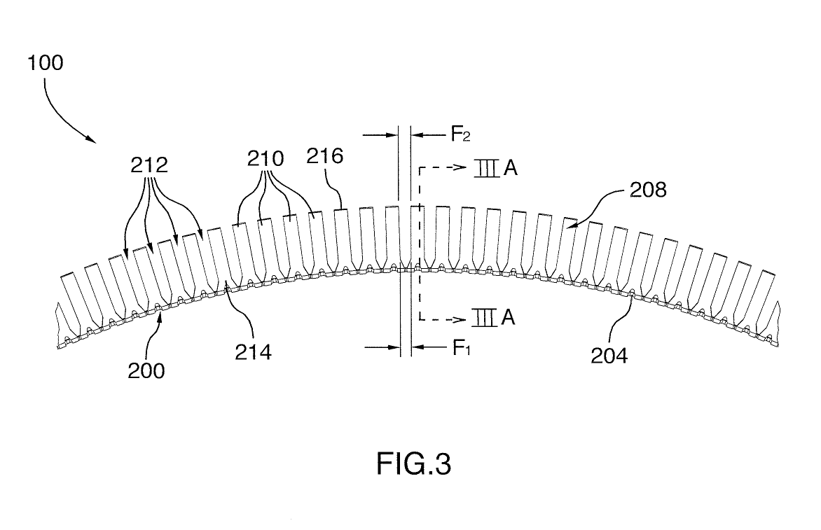

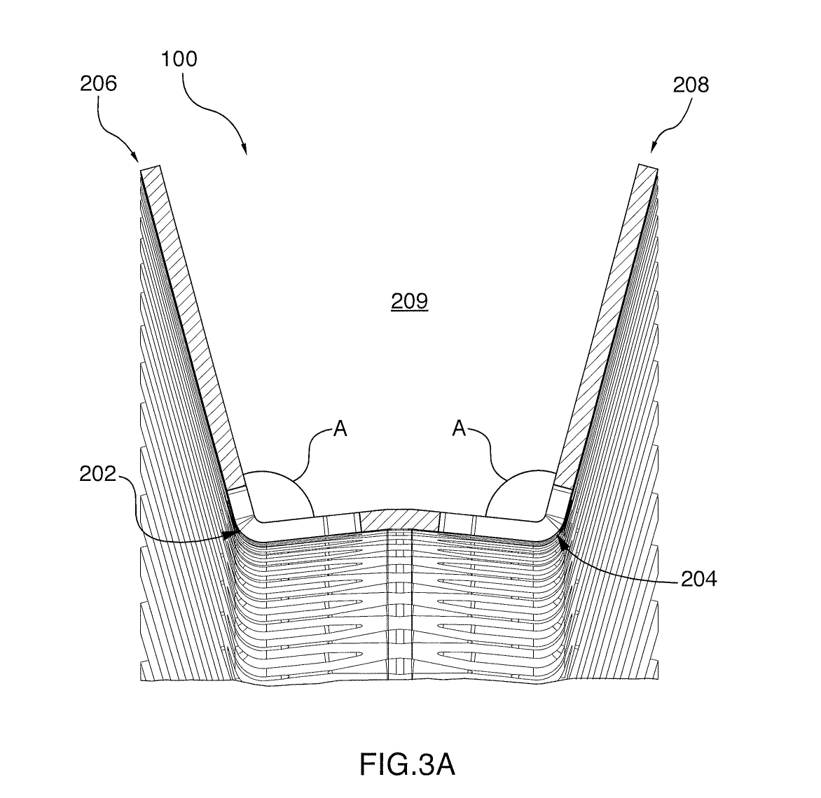

Now referring to FIGS. 2 to 3A, the metal insert 100 comprises an elongate central portion 200 having a pair of spaced-apart lateral edges 202, 204. In the illustrated embodiment, the elongate central portion 200 is generally rectangular and defines a central longitudinal axis C located generally centrally between the lateral edges 202, 204.

The metal insert 100 further comprises a pair of flaps 206, 208 which each extend from one of the lateral edges 104, 106 of the elongate central portion 200. In the embodiment illustrated in FIGS. 2 to 3A, the metal insert 100 is generally U-shaped. More specifically, each one of the flaps 206, 208 is folded at an angle A relative to the elongate central portion 200, as best shown in FIG. 3A. In this configuration, the flaps 206, 208 define between them a channel 209 for receiving a flange of the structure or vehicle, such as a perimeter flange of a car door frame for example, for mounting the weatherstrip seal 50 to the structure or vehicle to seal.

In the illustrated embodiment, the flaps 206, 208 and the elongate central portion 200 are integrally formed together from a single sheet of metal. In one embodiment, the metal comprises aluminum or an aluminum alloy. Alternatively, the metal could instead comprise steel, including but not limited to cold roll steel and low carbon steel, or any other metal which can be folded and shaped as described herein.

A skilled addressee will also understand that the term “metal insert” is sometimes used in the art to refer to parts which are not made of metal. Therefore, the metal insert 100 could instead be made of another non-metallic material such as plastic, if said plastic can be folded and shaped as described herein and is deemed by the skilled addressee to be fit for use within a weatherstrip seal.

A skilled addressee will appreciate that to allow the weatherstrip seal 50 to be properly retained on the flange of the structure or vehicle, the layer of elastomeric material 150 may define one or more projections or “grippers” (not shown) extending into the channel 209 from at least one of the flaps 206, 208. The metal insert 100 does not extend within the grippers, and the grippers are therefore flexible.

When the weatherstrip seal 50 is mounted on the flange of the structure or vehicle, the grippers are compressed between the flange and the flaps 206, 208 and create friction of the flange, thereby retaining the weatherstrip seal 50 on the flange. The amount of friction on the flange caused by the gripper therefore depends on the distance between the flaps 206, 208, which will define how the grippers are compressed on the flange.

In the illustrated embodiment, the metal insert 100 is adapted to allow the weatherstrip seal 50 to be curved substantially smoothly (i.e. to allow the weatherstrip seal 50 to maintain a substantially constant radius of curvature along at least a portion of its length) while the flaps 206, 208 remain at the same angle relative to the elongate central portion, as will be further explained below. The flaps 206, 208 will therefore not move apart when the weatherstrip seal 50 is curved lengthwise. Therefore, when the weatherstrip seal 50 is mounted on a flange of a structure or vehicle which includes linear portions and curved portions, the amount of friction caused by the grippers will be the same in the curved portions and in the linear portions. This will allow the weatherstrip seal 50 to be properly retained on the flange along its entire length.

To enable the metal insert 100 to be curved lengthwise, each one of the flaps 206, 208 comprises a plurality of tabs or fins 210 which are spaced apart from each other to define interstitial spaces 212 between adjacent fins. When the metal insert 100 is curved outwardly lengthwise, as shown in FIG. 3, the fins 210 fan out. More specifically, each fin 210 comprises a proximal end 214 located near the elongate central portion 200 and a distal end 216 located away from the elongate central portion 200. When the metal insert 100 is curved outwardly, the proximal ends 214 of adjacent fins are spaced from each other by a distance F₁ and the distal ends 216 of adjacent fins are spaced from each other by a distance F₂ which is greater than the distance F₁.

Furthermore, the interstitial spaces 212 have a width which is selected to also allow the metal insert 100 to be curved smoothly inwardly. More specifically, when the metal insert 100 is curved inwardly lengthwise, the proximal ends 214 of adjacent fins are spaced from each other by a distance F₁ and the distal ends 216 of adjacent fins are spaced from each other by a distance F₂ which is less than the distance F₁.

In the illustrated embodiments, all of the interstitial spaces 212 have the same width. Alternatively, the interstitial spaces 212 could have different widths.

In the illustrated embodiment, the metal insert 100 is generally symmetrical about the central longitudinal axis C. Specifically, all of the fins 210 generally have the same length and shape. Alternatively, the formed metal insert 100 could instead be asymmetrical. For example, the fins 210 of one of the flaps 206, 208 may have different lengths than the fins 210 of the other one of the flaps. The length of the fins 210 could also vary along the length of the metal insert 100. In yet another embodiment, the flaps 206, 208 may only comprise fins 210 on one or more portions of their length, instead of along their entire length.

In the illustrated embodiment, the fins 210 are generally rectangular. Alternatively, the fins 210 may have various other shapes.

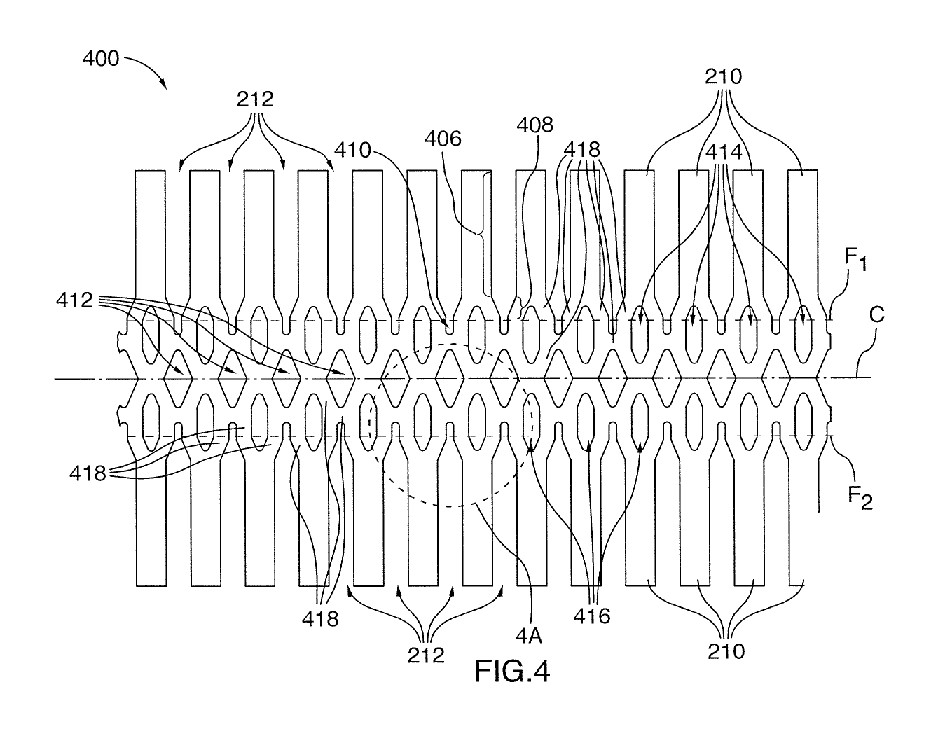

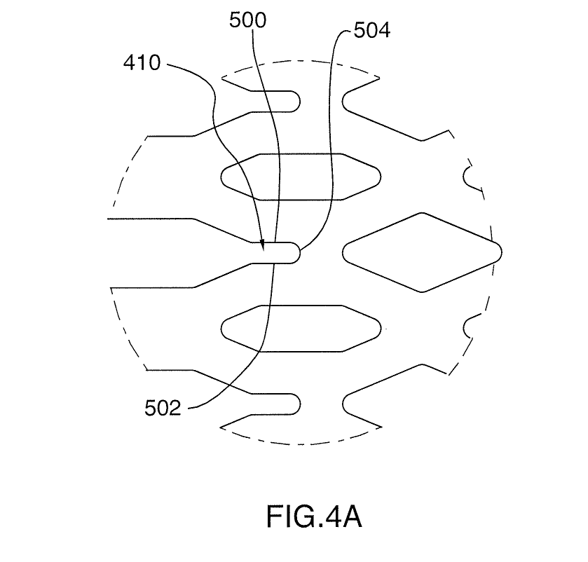

Now turning to FIGS. 4 and 4A, there is shown the metal insert 100 in a non-folded configuration (i.e. prior to being folded to complete its manufacturing). To form the metal insert 100 into its operative configuration as illustrated in FIGS. 2 to 3A, the metal insert 100 in the non-folded configuration is bent or folded along folding axes F₁ and F₂, which are parallel to the central longitudinal axis C, to form the flaps 206, 208.

In the illustrated embodiment, the metal insert 100 in the non-folded configuration comprises a first side edge 402 and a second side edge 404 and the interstitial spaces 212 are defined as indents extending inwardly from the first and second side edges 402, 404 of the metal insert 100 towards the central longitudinal axis C of the metal insert 100.

As shown in FIG. 4, the metal insert 100 is symmetrical about the central longitudinal axis C. In this configuration, each interstitial space 212 is transversely aligned with an opposed interstitial space 212 located on the opposed side of the central longitudinal axis C.

In one embodiment, the distal portion 406 of the interstitial space 212 has a width of about 2.5 mm, and each fin has a width of about 3 mm.

Each interstitial space 212 comprises a generally straight distal portion 406 located away from the central longitudinal axis C and an inner end portion 408 located near the central longitudinal axis C.

In the illustrated embodiment, the inner end portion 408 tapers towards the central longitudinal axis C. In this embodiment, the inner end portion 408 has a taper angle of about 45.5 degrees. Alternatively, the inner end portion 408 could be straight or rounded.

Each interstitial space 212 further comprises a notch 410 which extends inwardly from the inner end portion 408 towards the central longitudinal axis C. In the illustrated embodiment, each notch 410 is generally straight and extends generally perpendicularly to the central longitudinal axis C.

As best shown in FIG. 4A, the notch 410 further extends beyond a corresponding one of the folding axes F₁ and F₂. It has been found that this configuration allows the flaps 206, 208 to remain at the same angle relative to the elongate central portion 200 when the metal insert 100 is curved lengthwise outwardly or inwardly, as shown in FIGS. 2 to 3A. For example, if the flaps 206, 208 are folded relative to the elongate central portion 200 such that the flaps 206, 208 are perpendicular to the elongate central portion 200 and parallel to each other, the flaps 206, 208 will remain parallel to each other when the metal insert 100 is curved lengthwise. Alternatively, the flaps 206, 208 could instead be folded at an obtuse angle relative to the elongate central portion 200, or even at an acute angle relative to the elongate central portion 200.

Specifically, each notch 410 comprises two spaced-apart side edges 500, 502 which are parallel to each other and an inner corner 504 extending between the two spaced-apart side edges 500, 502.

In the embodiment illustrated in FIG. 4A, the notch 410 has a length of about 1.67 mm and the two spaced-apart side edges 500, 502 are spaced apart by a distance of about 0.76 mm. Alternatively, the two spaced-apart side edges 500, 502 are spaced apart by a distance which is smaller than about 0.76 mm, or even which is greater than 0.76 mm.

Still in the illustrated embodiment, the inner corner 504 is rounded. This configuration contributes to preventing cracks from forming inwardly form the notches 410 towards the central longitudinal axis C when the metal insert 100 is curved. In one embodiment, the inner corner 504 is rounded at a radius of about 0.38 mm.

It will be understood that the notch 410 could be shaped and sized differently, as long as it extends beyond the corresponding folding axis F₁ or F₂.

The metal insert 100 further comprises a plurality of openings disposed according to a predetermined pattern in the metal insert 100. When the layer of elastomeric material 150 is applied over the metal insert 100, some elastomeric material will flow inside the openings and thereby contribute to anchoring the layer of elastomeric material 150 on the metal insert 100.

In the illustrated embodiment, the metal insert 100 comprises a row of central openings 412 which are aligned along the central longitudinal axis C. Still in the illustrated embodiment, the central openings 412 are generally diamond-shaped. In one embodiment, each central opening 412 has a transverse width of about 5.8 mm, and the corners of the central opening 412 are rounded at a radius of about 0.38 mm. Alternatively, the central openings 412 could have different shapes and/or dimensions.

In the illustrated embodiment, the metal insert 100 further comprises a pair of rows of lateral openings 414, 416 which are off-centered and generally symmetrical to each other about the central longitudinal axis C. Still in the illustrated embodiment, the lateral openings 414, 416 are generally hexagonal and generally elongate in a direction transverse to the central longitudinal axis C. In one embodiment, each lateral opening 414, 416 has a transverse width of about 5.8 mm and a longitudinal height of about 1.68 mm. The corners of the lateral openings 414, 416 may further be rounded at a radius of about 0.38 mm. Alternatively, the lateral openings 414, 416 could have different shapes and/or dimensions.

In the illustrated embodiment, the central openings 412 and the lateral openings 414, 416 are disposed in a staggered pattern on the metal insert 100. More specifically, the central openings 412 are transversely aligned with the interstitial spaces 212 and the lateral openings 414, 416 are transversely aligned with the fins 210.

It will be appreciated that the central openings 412 and the lateral openings 414, 416 define a webbing structure in the elongate central portion 200 between the fins 210 on both sides of the central longitudinal axis C. This webbing structure comprises a web of webbing strips 418 which surround the central openings 412 and the lateral openings 414, 416. In one embodiment, this webbing structure does not comprise any webbing strip 418 having a width which is smaller than a predetermined minimum width. This configuration provides the metal insert 100 with a predetermined minimum tensile strength. For example, the metal insert 100 may have a tensile strength of 420 N. This may allow the metal insert 100 to meet certain tensile strength requirements.

In one embodiment, all of the webbing strips 418 have the same width. This configuration contributes to a uniform tensile strength distribution in the metal insert 100 by eliminating areas which, by being thinner than other areas, would create weaknesses in the metal insert 100. In one example, all of the webbing strips 418 have a width of 1.53 mm.

It will be appreciated that the configuration of the metal insert 100 described herein possesses a number of advantages over prior configurations. For example, this configuration may enable the manufacturing, from aluminum or an alloy thereof, of a metal insert which has interstitial spaces having a width of at least 2.5 mm, which could have the ability to be curved substantially smoothly while the fins remain at the same angle relative to the elongate central portion and which could further have a tensile strength of at least 420 N.

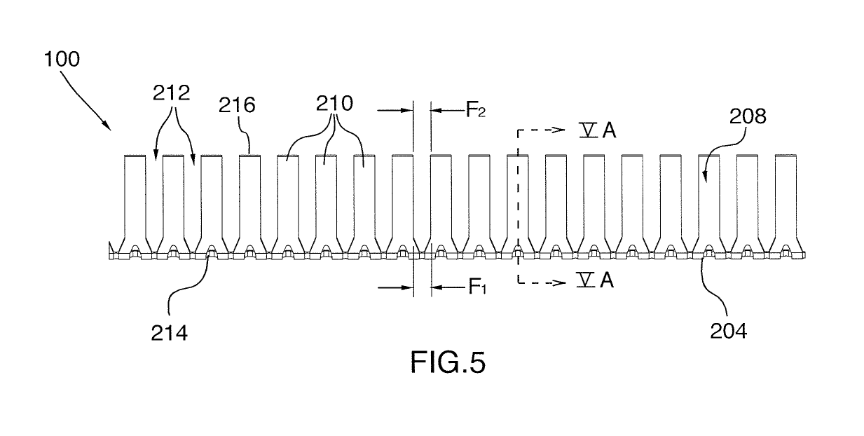

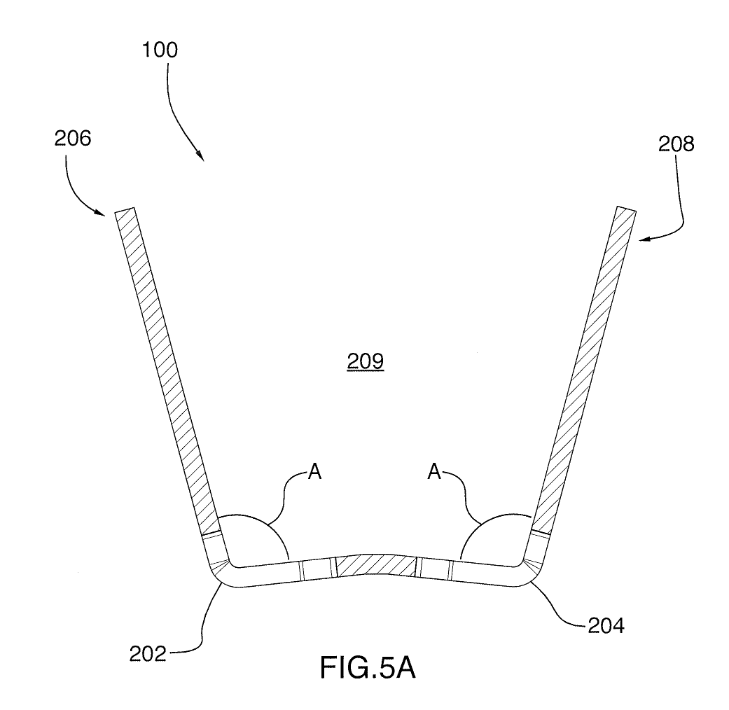

Now turning to FIGS. 5 and 5A, there is shown the metal insert 100 is a linear configuration (i.e. not curved). As best shown in FIG. 5A, the angle A between the flaps 206, 208 and the elongate central portion 200 remains the same regardless of whether the metal insert 100 is curved lengthwise or not, as explained above.

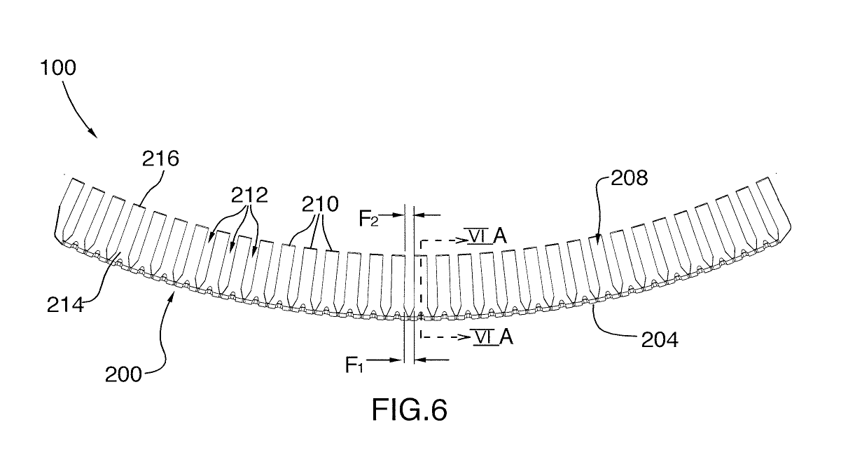

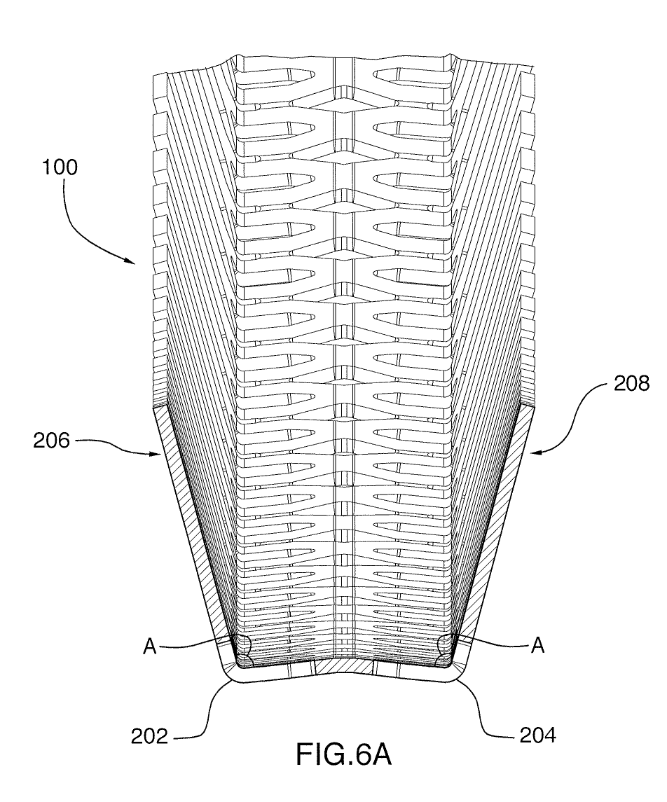

Now turning to FIGS. 6 and 6A, there is shown the metal insert 100 curved inwardly. As best shown in FIG. 6A, the angle A between the flaps 206, 208 and the elongate central portion 200 still remains the same regardless of whether the metal insert 100 is curved lengthwise or not, as explained above, and regardless of whether the metal insert 100 is curved inwardly or outwardly.

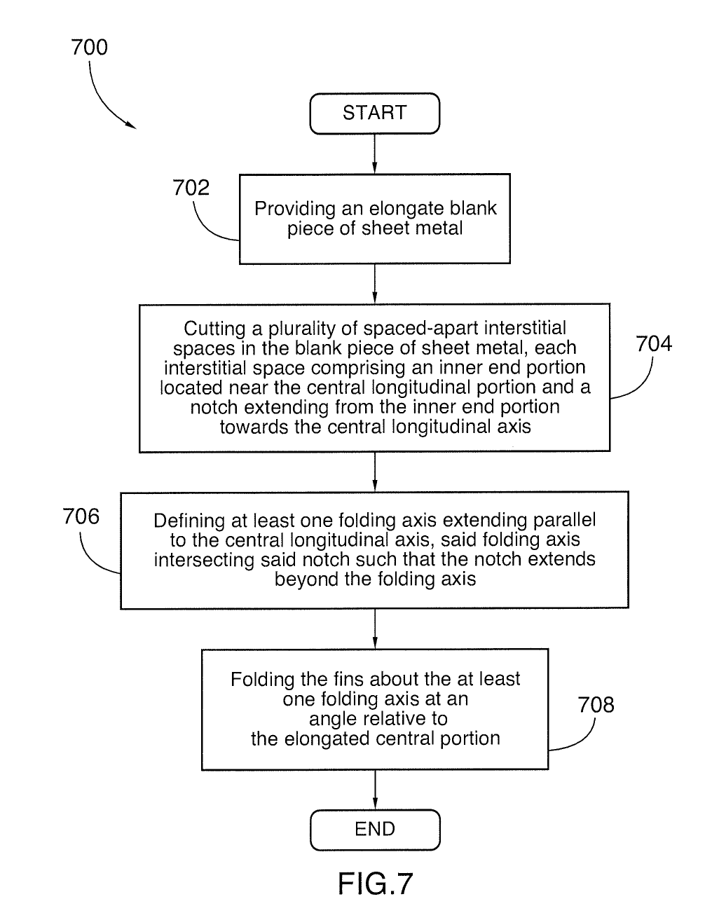

Now referring to FIG. 7, a method 700 for manufacturing the metal insert 100 will be described, in accordance with one embodiment.

According to 702, an elongate blank piece of sheet metal is first provided. The elongate blank piece of sheet metal has a first lateral edge, a second lateral edge and a central longitudinal axis.

According to 704, a plurality of spaced-apart interstitial spaces are cut in the blank piece of sheet metal. The interstitial spaces extend from at least one of the lateral edges towards the central longitudinal axis. Each interstitial space comprises an inner end portion located near the central longitudinal portion and a notch extending from the inner end portion towards the central longitudinal axis. Specifically, the interstitial spaces being spaced apart to define a plurality of fins between adjacent interstitial spaces.

In one embodiment, a row of central openings aligned with the central longitudinal axis and a pair of rows of lateral openings offset from the central longitudinal axis are also simultaneously cut in the blank piece of sheet metal. In this embodiment, the metal insert 100 in the non-folded configuration, as shown in FIGS. 4 and 4A, is thereby obtained.

In one embodiment, the central openings, the lateral openings and the interstitial spaces are cut by stamping. Alternatively, the central openings, the lateral openings and the interstitial spaces may be made by other manufacturing techniques known to the skilled addressee.

According to 706, at least one folding axis extending parallel to the central longitudinal axis is defined on the piece of sheet metal. Each folding axis delimits a flap, which includes the fins defined by the interstitial spaces, from an elongate central portion. Furthermore, each folding axis intersects the notch of the interstitial space such that the notch extends beyond the folding axis.

According to 708, the fins are folded about the at least one folding axis at an angle relative to the elongate central portion. The metal insert 100 as shown in FIGS. 2 to 3A is thereby obtained.

In one embodiment, the weatherstrip seal 50 is further manufactured using the metal insert 100. Specifically, the metal insert 100 described above is provided and is covered with the layer of elastomeric material 150. In one embodiment, the layer of elastomeric material 150 is extruded over the metal insert 100. Alternatively, the layer of elastomeric material 150 could be molded over the metal insert 100. It will be understood that the layer of elastomeric material could have generally the same cross-section as the metal insert 100 (e.g. a U-shaped cross-section), or could have a different cross-section which at least covers the metal insert 100, but also includes lateral flexible extensions which further contribute to the sealing abilities of the weatherstrip seal 50. Furthermore, grippers could also be provided on the layer of elastomeric material, as explained above.

Once the layer of elastomeric material 150 is extruded over the metal insert 100, the layer of elastomeric material 150 is then cured and the weatherstrip seal 50 is thereby obtained.

In one embodiment, a vehicle comprising the weatherstrip seal described herein could also be provided. In this embodiment, the weatherstrip seal can be mounted on a flange of the vehicle as described above, or to any other receiving structure of the vehicle.

It will be understood that the embodiments described above are intended to be exemplary only. The scope of the invention is therefore intended to be limited solely by the scope of the appended claims.

1. A metal insert for a weatherstrip seal comprising:
an elongate central portion having a pair of spaced-apart lateral edges and a central longitudinal axis; and
at least one flap extending from one of the spaced-apart lateral edges, the at least one flap being folded at an angle relative to the elongate central portion about a folding axis generally parallel to the central longitudinal axis, the at least one flap comprising a plurality of fins spaced apart to define interstitial spaces between adjacent fins, each interstitial space comprising an inner end portion located near the central longitudinal portion and a notch extending from the inner end portion towards the central longitudinal axis and beyond the folding axis.

2. The metal insert as claimed in claim 1, wherein the notch comprises two spaced-apart side edges and an inner corner extending between the two spaced-apart side edges.

3. The metal insert as claimed in claim 2, wherein the two spaced-apart edges are parallel to each other.

4. The metal insert as claimed in claim 3, wherein the two spaced-apart edges are perpendicular to the central longitudinal axis of the elongate central portion.

5. The metal insert as claimed in claim 3, wherein the two spaced-apart edges are spaced by a distance of no more than about 0.76 mm.

6. The metal insert as claimed in claim 2, wherein the inner corner is rounded.

7. The metal insert as claimed in claim 6, wherein the inner corner is rounded at a radius of about 0.38 mm.

8. The metal insert as claimed in claim 1, wherein the inner end portion of each interstitial space tapers from the adjacent fins towards the central longitudinal axis of the elongate central portion.

9. The metal insert as claimed in claim 1 further comprising a plurality of openings extending through the elongate central portion and disposed according to a predetermined pattern thereon.

10. The metal insert as claimed in claim 9, wherein the plurality of openings comprises a row of central openings aligned along the central longitudinal axis of the elongate central portion.

11. The metal insert as claimed in claim 10, wherein the plurality of openings further comprises a pair of rows of lateral openings off-centered relative to the central longitudinal axis and symmetrical to each other about the central longitudinal axis.

12. The metal insert as claimed in claim 11, wherein the central openings and the lateral openings are disposed in a staggered pattern.

13. The metal insert as claimed in claim 12, wherein the central openings are diamond-shaped.

14. The metal insert as claimed in claim 13, wherein the lateral openings are hexagonal.

15. The metal insert as claimed in claim 14, wherein the elongate central portion comprises a web of webbing strips surrounding the central openings and the lateral openings.

16. The metal insert as claimed in claim 15, wherein all of the webbing strips have the same width.

17. The metal insert as claimed in claim 1, wherein the at least one flap and the elongate central portion are integrally formed together from a sheet of metal.

18. The metal insert as claimed in claim 17, wherein the metal is selected from a group consisting of: aluminum and an alloy thereof.

19. A weatherstrip seal comprising:
a metal insert comprising:
an elongate central portion having a pair of spaced-apart lateral edges and a central longitudinal axis;
at least one flap extending from one of the spaced-apart lateral edges, the at least one flap being folded at an angle relative to the elongate central portion about a folding axis generally parallel to the central longitudinal axis, the at least one flap comprising a plurality of fins spaced apart to define interstitial spaces between adjacent fins, each interstitial space comprising an inner end portion located near the central longitudinal portion and a notch extending from the inner end portion towards the central longitudinal axis and beyond the folding axis; and
a layer of elastomeric material covering the metal insert.

20. A method for manufacturing a metal insert for a weatherstrip seal, the method comprising:
providing an elongate blank piece of sheet metal having a first lateral edge, a second lateral edge and a central longitudinal axis;
cutting a plurality of spaced-apart interstitial spaces in the blank piece of sheet metal, the interstitial spaces extending from at least one of the lateral edges towards the central longitudinal axis, each interstitial space comprising an inner end portion located near the central longitudinal portion and a notch extending from the inner end portion towards the central longitudinal axis, the interstitial spaces being spaced apart to define a plurality of fins between adjacent interstitial spaces;
defining at least one folding axis extending parallel to the central longitudinal axis, each folding axis delimiting a flap including the fins from an elongate central portion, said folding axis intersecting said notch such that the notch extends beyond the folding axis;
folding the fins about the at least one folding axis at an angle relative to the elongate central portion.
